(19) United States
(12) Patent Application Publication
(10) Pub. No.: US 2017/0372574 A1
(43) Pub. Date: Dec. 28, 2017

(54) BEACON-AUGMENTED SURVEILLANCE SYSTEMS AND METHODS

(71) Applicant: QUALCOMM Incorporated, San Diego, CA (US)

(72) Inventor: Joel Benjamin LINSKY, San Diego, CA (US)

(21) Appl. No.: 15/192,157

(22) Filed: Jun. 24, 2016

(51) Int. Cl. G08B 13/196; H04N 5/92; H04N 5/77; H04N 7/18; H04N 7/08

(52) U.S. Cl. CPC G08B 13/1966; H04N 7/183; H04N 7/08; G08B 13/19641; H04N 5/77; G08B 13/19671; H04N 5/9201

(57) ABSTRACT

Systems and methods are disclosed for operating a surveillance system and managing beacon-augmented surveillance data. A surveillance system may include a camera, a controller, and a transceiver. The camera may be configured to generate image data. The controller may be configured to generate image metadata that indicates a surveillance system identifier, upload the image data and the image metadata to a server, and generate a beacon that indicates the surveillance system identifier. The transceiver may be configured to transmit the beacon.

Aspects of this disclosure relate generally to surveillance systems, and more particularly to systems and methods for augmenting surveillance systems with beacons.

Video cameras are commonly used in surveillance systems. In some implementations, image data captured by a video camera is recorded. However, recorded video may not be sufficient for providing necessary surveillance information, i.e., recognizing crimes or abnormalities and identifying trespassers, thieves, and witnesses.

Beacon signals, which may be referred to as beacons, are increasingly used to wirelessly share information with proximate wireless devices. The beacons may be transmitted by beacon transmitters, for example, wireless access points, wireless access terminals, or dedicated beacon transmission devices. Beacon systems have various applications, many of which are based on proximity. For example, a beacon transmitter may generate targeted advertising or public service information for a select group of proximate wireless devices. A network of beacon transmitters may be used to facilitate proximity-based tracking services of mobile wireless devices. The range of a beacon transmitter may be selected based on known trade-offs. For example, greater range may maximize the reach of the beacon transmitter, but may consume more resources and reduce the precision of proximity determinations.

Wireless devices may be configured to receive beacons via standard transceivers, for example, short-range radio frequency transceivers, wireless local area network transceivers, or wireless wide area network transceivers. The wireless device may be further configured to process beacons. For example, a beacon may contain data that indicates an identity of the beacon transmitter, data that indicates a characteristic of the beacon transmitter, data that shares information with the wireless device, and/or data that indicates a location at which the wireless device can access additional information. In some implementations, the wireless device may be configured to automatically perform one or more actions in response to beacon reception.

As an example, a shoe retailer may purchase a beacon transmitter that transmits beacons. Wireless devices may be equipped with advertising applications in which the user of a particular wireless device identifies goods or services of interest, for example, shoes. If the user approaches within a certain proximity of the shoe retailer, a beacon from the beacon transmitter may be received by the wireless device.

The advertising application may be configured to, for example, upload a beacon transmitter identifier to a remote server. The server may be configured to process the beacon transmitter identifier and notify the wireless device that the beacon transmitter is associated with a shoe retailer. This may enable the advertising application to determine that the shoe retailer's message may be of interest to the user. The advertising application may then notify the user of the shoe retailer's proximity.

As beacon systems become more common, wireless devices will increasingly rely on beacon-related services. However, beacon systems have not yet been leveraged to augment surveillance systems. New solutions are needed in which beacon systems assist in recognizing crimes or abnormalities and identifying trespassers, thieves, and witnesses.

### SUMMARY

The following summary is an overview provided solely to aid in the description of various aspects of the disclosure and is provided solely for illustration of the aspects and not limitation thereof.

In one example, a method of operating a surveillance system is disclosed. The method may include, for example, generating image data, generating image metadata that indicates a surveillance system identifier, transmitting the image data and the image metadata to a server, generating a beacon that indicates the surveillance system identifier, and transmitting the beacon.

In another example, a surveillance system apparatus is disclosed. The surveillance system apparatus may include, for example, a camera configured to generate image data, a controller configured to generate image metadata that indicates a surveillance system identifier, upload the image data and the image metadata to a server, and generate a beacon that indicates the surveillance system identifier, and a transceiver configured to transmit the beacon.

In another example, a method of managing beacon-augmented surveillance data is disclosed. The method may include, for example, receiving image data and image metadata from a surveillance system, wherein the image metadata indicates a surveillance system identifier of the surveillance system, receiving a beacon reception notification from a wireless device, wherein the beacon reception notification indicates a wireless device identifier associated with the wireless device and the surveillance system identifier of the surveillance system, determining that both the image metadata and the beacon reception notification indicate the surveillance system identifier, associating the image data received from the surveillance system and the wireless device identifier received from the wireless device with the surveillance system identifier, and storing the image data in accordance with the associating.

In another example, a server apparatus is disclosed. The server apparatus may be configured to, for example, receive image data and image metadata from a surveillance system, wherein the image metadata indicates a surveillance system identifier of the surveillance system, receive a beacon reception notification from a wireless device, wherein the beacon reception notification indicates a wireless device identifier associated with the wireless device and the surveillance system identifier of the surveillance system, determine that both the image metadata and the beacon reception notification indicate the surveillance system identifier, associate the image data received from the surveillance system and the wireless device identifier received from the wireless device with the surveillance system identifier, and store the image data in accordance with the associating.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 generally illustrates a wireless communications environment in accordance with an aspect of the disclosure.

FIG. 2 generally illustrates a method of operating a beacon-augmented surveillance system in accordance with an aspect of the disclosure.

FIG. 3 generally illustrates a method of generating and transmitting a beacon reception notification in accordance with an aspect of the disclosure.

FIG. 4 generally illustrates a method of managing beacon-augmented surveillance data in accordance with an aspect of the disclosure.

FIG. 5 generally illustrates beacon-augmented surveillance data as it might be managed in accordance with the method of FIG. 4.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention. The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage, or mode of operation. Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

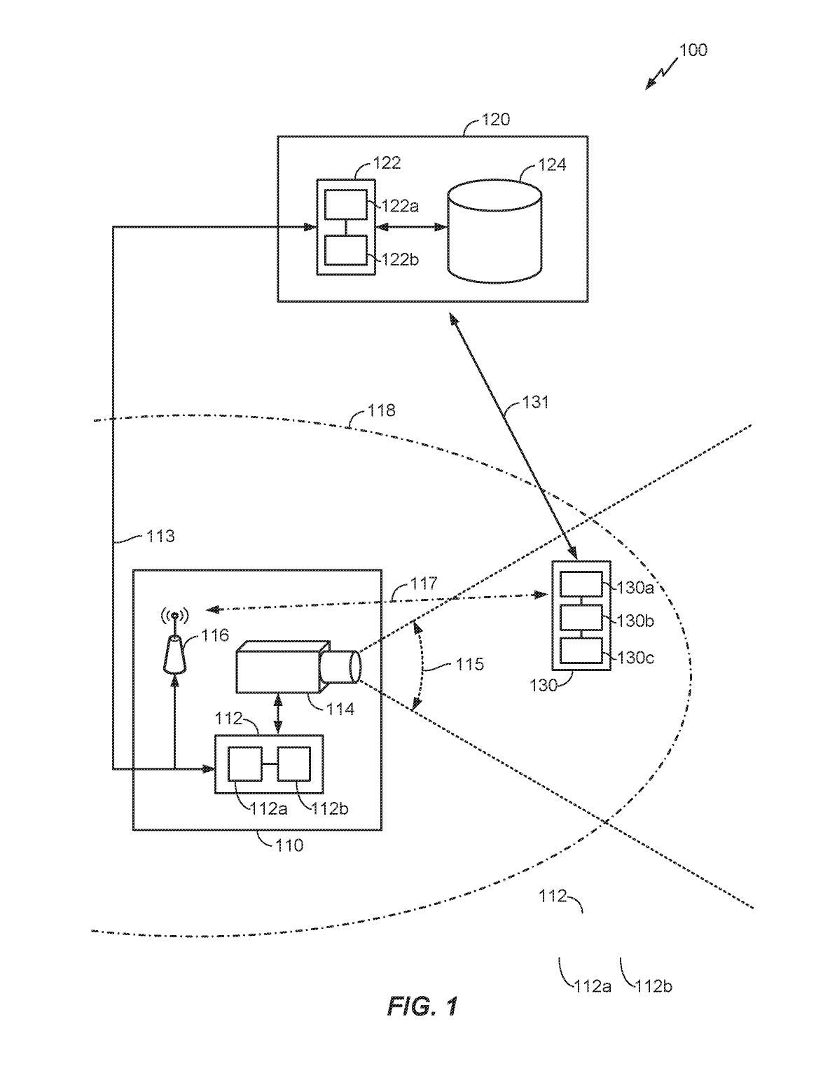

FIG. 1 illustrates a wireless communications environment 100 in accordance with an aspect of the disclosure. The wireless communications environment 100 includes a surveillance system 110, a server 120, and a wireless device 130.

The surveillance system 110 may include a controller 112. The controller 112 may control and coordinate the actions performed by the surveillance system 110, for example, by operating a camera 114 and a beacon transmitter 116. The controller 112 may also communicate with the server 120 via a communication channel 113. The communication channel 113 may operate in accordance with any wired or wireless communication protocol. Although FIG. 1 depicts a direct two-way link between the surveillance system 110 and the server 120, it will be understood that the communication channel 113 may be a one-way link from the wireless device 130 to the server 120 and that the link may be direct or indirect, for example, the communications between the surveillance system 110 and the server 120 may be routed, relayed, re-routed, etc., via any suitable communication network.

The controller 112 may be implemented using, for example, a surveillance system processor 112a and a surveillance system memory 112b coupled to the surveillance system processor 112a. Additionally or alternatively, the controller 112 may be implemented using an application-specific integrated circuit (ASIC).

The camera 114 may be configured to generate image data. The image data may be provided to the controller 112 for storage, processing, display, and/or transmission. The camera 114 may capture image data within a surveillance imaging zone 115. The surveillance imaging zone 115 may be a physical area from which the camera 114 can obtain image data. The shape and extent of the surveillance imaging zone 115 may be a function of the position and orientation of the camera 114. The position and orientation of the camera 114 may be static or dynamic, and may be controlled by the controller 112.

Although only a single camera 114 having a single surveillance imaging zone 115 is depicted in FIG. 1, it will be understood that the surveillance system 110 may include a plurality of cameras.

The controller 112 may include a local storage element for storing image data received from the camera 114, for example, the surveillance system memory 112b and/or an additional memory (not shown). Additionally or alternatively, the controller 112 may transmit the image data to a remote server, for example, the server 120 depicted in FIG. 1. The controller 112 may generate image metadata and process the image data to include the image metadata. The image metadata may include, for example, a surveillance system identifier that is associated with the surveillance system 110, a camera identifier that is associated with the camera 114, a camera position indicator that indicates a position or orientation of the camera 114, an image timestamp indicating a time at which the image data was captured, other data, or any combination thereof.

As used herein, the term “timestamp” may refer to a time at which an event occurred and/or a time interval during which one or more events occurred. The time or time interval may be precise or approximate, and may be based on coordinated universal time, local time, or arbitrary local time (for example, as defined by a local clock signal).

The controller 112 may process the image data by incorporating the image metadata. The image metadata may be incorporated by associating the image metadata with the image data prior to storage and/or transmission. Additionally or alternatively, the image metadata may be converted to graphics (for example, text) and superimposed on the image data.

The subject of the surveillance system 110 may be a protected person or object within the surveillance imaging zone 115 (for example, a child or a cash register) and/or a point of ingress and egress with respect to a protected person or object (for example, a security gate or vault door). The user of the surveillance system 110 may be able to remotely observe the subject and respond quickly if a crime or abnormality is occurring within the surveillance imaging zone 115. Additionally or alternatively, the surveillance system 110 may record image data that may be used to investigate a past occurrence of a crime or abnormality. In some instances, the crime or abnormality may occur outside of the surveillance imaging zone 115, but the image data generated by the camera 114 may nevertheless facilitate investigation of the crime or abnormality.

The investigation of an occurrence may hinge upon the identification of a person whose image is captured by the camera 114. However, the image data provided by the camera 114 may not be sufficient to perform the identification. For example, the resolution of the camera 114 may not be sufficient to reveal important details, the person's face may not be facing the camera 114, or the person may be in disguise. Moreover, even if a clear likeness of the person is captured in the image data, the likeness may not be easily traceable to the person. As a result, the effectiveness of the surveillance system 110 may be limited.

The beacon transmitter 116 included in the surveillance system 110 may be configured to transmit a beacon 117. A plurality of beacons 117 may be transmitted continuously or intermittently, for example, periodically. The surveillance system 110 may rely on relatively short-range wireless signaling (for example, short-range radio signals, Bluetooth Low Energy packets or signals, light signals, sound signals, etc.) to transmit the beacon 117. Accordingly, the wireless device 130 may only receive the beacon 117 if it is within a certain proximity of the surveillance system 110. In particular, the beacon transmitter 116 may be associated with a beacon transmission zone 118. The beacon transmission zone 118 and the surveillance imaging zone 115 may overlap in full or in part. For example, in some implementations, at least a portion of the surveillance imaging zone 115 overlaps with at least a portion of the beacon transmission zone 118.

In some implementations, the beacon transmitter 116 may be a dedicated one-way transmitter. In other implementations, the beacon transmitter 116 may be implemented using a wireless access point. Although the communication channel 113 between the surveillance system 110 and the server 120 is depicted in FIG. 1 as being distinct from the beacon transmitter 116, it will be understood that the surveillance system 110 may include a single transceiver that is configured to communicate with the server 120 as well as transmit the beacon 117.

The beacon 117 may include beacon data. The beacon data may include beacon identifier data, beacon characteristic data, payload data, other data, or any combination thereof. The beacon identifier data may indicate an identity of the beacon transmitter 116 and/or an identity of a user of the beacon transmitter 116. The beacon data may include beacon characteristic data that indicates a characteristic of the beacon transmitter 116 or beacon 117. The beacon data may include payload data. The payload data may include media content, for example, text, audio, and/or video. Additionally or alternatively, the payload data may include instructions for processing media content. Additionally or alternatively, the payload data may include links to external media content, for example, media content stored on a remote server, possibly the server 120.

In some implementations, the beacon 117 may include beacon identifier data that is changed (or “rolled”) periodically in a manner that is known to a central server but that is difficult for an unauthorized system to predict. For example, the surveillance system 110 may be associated with a unique device identifier, for example, a factory-assigned ID number. The unique device identifier, along with other data (e.g., nonce values, counter values, timestamps, etc.), may be encoded, encrypted, or otherwise obfuscated when included within a beacon 117. The term “rolling identifier” is used herein to refer to an identifying code, unique to a device or a user of the device, that is periodically changed (i.e., “rolled”). The use of a rolling identifier can make it difficult for unauthorized devices to identify the beacon transmitter 116. A rolling identifier for the surveillance system 110 can be created and changed using a variety of encryption and/or encoding techniques. For example, the surveillance system 110 may be configured to maintain relatively accurate time (for example, UTC) information, such as by using a thirty ppm, sixteen kHz crystal oscillator as a clock. The beacon 117 may include other identifying information, such as Bluetooth® MAC addresses and nonces or counters, which may also be encrypted. The beacon 117 may be transmitted via a wireless communication protocol such as Bluetooth Low Energy, WiFi, WiFi Direct, Zigbee®, Peanut®, or other limited range RF communication protocols.

The wireless communications environment 100 further includes a server 120, as noted above. The server 120 may include a server controller 122 and a server database 124. The server controller 122 may include a server processor 122a and a server memory 122b coupled to the server processor 122a. Although the server memory 122b and server database 124 are shown as distinct elements, it will be understood that these elements may be combined. The server controller 122 may be configured to receive image data and image metadata from the surveillance system 110 via the communication channel 113. The server controller 122 may be further configured to determine a surveillance system identifier of the surveillance system 110 from which the image data and image metadata are received.

Although FIG. 1 depicts the server 120 as being remote from the surveillance system 110, it will be understood that in some implementations, the server 120 may be included in the surveillance system 110. For example, the controller 112 and the server controller 122 may be combined such that the actions respectively performed by the controller 112 and the server controller 122 are performed by a single device.

In some implementations, the server controller 122 may determine the surveillance system identifier of the surveillance system 110 by decoding the image metadata. In other implementations, the server controller 122 may determine the surveillance system identifier of the surveillance system 110 by deciphering a rolling identifier that is provided in the image metadata.

The server controller 122 may be further configured to associate the image data and/or image metadata received from the surveillance system 110 with the surveillance system identifier of the surveillance system 110. The server controller 122 may be further configured to store the image data received from the surveillance system 110 in the server database 124. The image data may be stored in the server database 124 in accordance with the associating. For example, the image data received from the surveillance system 110 may be stored such that it can be retrieved in response to a query regarding the particular surveillance system identifier of the surveillance system 110.

The server controller 122 may be further configured to notify a public safety provider of the image data. For example, if a user of the surveillance system 110 determines that a crime or abnormality has occurred, the user of the surveillance system 110 may access the server 120 and/or contact the operator of the server 120. The server controller 122 may then notify a public safety provider, for example, police or fire investigators, that evidence relating to a crime or abnormality has been obtained. The server controller 122 may be further configured to transmit the image data to the public safety provider. The transmission may include, for example, transmission of the image data to the public safety provider via the communication channel 113.

The wireless communications environment 100 further includes a wireless device 130, as noted above. The wireless device 130 may include a wireless device processor 130a, a wireless device memory 130b coupled to the wireless device processor 130a, and/or a wireless device transmitter 130c. The wireless device 130 may be a cellular telephone or any other wireless device, mobile or stationary, handheld or otherwise, that includes at least one transceiver of wireless signals. The at least one transceiver may be included in the wireless device transmitter 130c.

The at least one transceiver included in the wireless device transmitter 130c may be configured to transmit and/or receive in accordance with one or more wireless protocols (for example, a wireless wide area network (WWAN) transceiver, a wireless local area network (WLAN) transceiver, a Bluetooth transceiver, etc.

The wireless device 130 may be equipped with processor-executable instructions, such as an application that users may download or that may be incorporated in the wireless device 130 by the manufacturer. The instructions may be stored, for example, in the wireless device memory 130b, and may be configured to cause the wireless device 130 to perform operations. In particular, the wireless device 130 may be configured to listen, using the wireless device transmitter 130c, for transmissions from beacon transmitters (such as beacon transmitter 116). The wireless device 130 may be further configured to notify, using the wireless device processor 130a and/or the wireless device transmitter 130c, the server 120 when a beacon (such as beacon 117) is received. In some implementations, the notification of the server 120 may be an automatic response to a beacon reception. For example, the notification may be performed without notification of or authorization from the user of the wireless device 130.

In order to notify the server 120 that a beacon (such as beacon 117) has been received, the wireless device 130 may be configured to generate a beacon reception notification 131. The beacon reception notification 131 may include part or all of the information encoded in received beacon 117 (including the surveillance system identifier associated with the surveillance system 110), a wireless device identifier associated with the wireless device 130, a beacon timestamp, authentication information, other data, or any combination thereof. The generating of the beacon reception notification 131 may be performed by, for example, the wireless device processor 130a.

The wireless device 130 may be further configured to transmit the beacon reception notification 131 to the server 120. Although FIG. 1 depicts a direct two-way link between the wireless device 130 and the server 120, it will be understood that the beacon reception notification 131 may be transmitted on a one-way link from the wireless device 130 to the server 120 and that the link may be direct or indirect, for example, the beacon reception notification 131 may be routed, relayed, re-routed, etc., via any suitable communication network. The transmitting of the beacon reception notification 131 may be performed by, for example, the wireless device transmitter 130c.

The server 120 included in the wireless communications environment 100 may be configured to receive and/or process the beacon reception notification 131. For example, the server controller 122 may be configured to receive the beacon reception notification 131 from the wireless device 130. As noted above, the beacon reception notification 131 may include part or all of the information encoded in received beacon 117 (including the surveillance system identifier associated with the surveillance system 110), a wireless device identifier associated with the wireless device 130, a beacon timestamp, authentication information, other data, or any combination thereof.

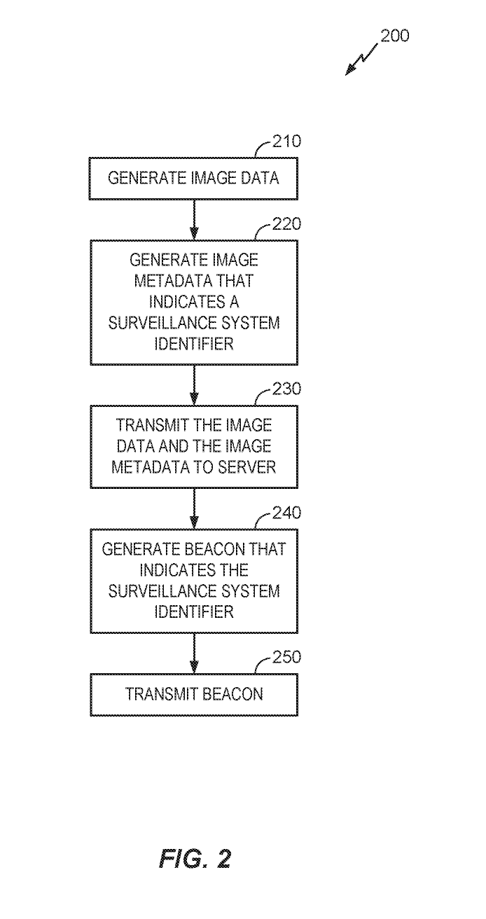

FIG. 2 generally illustrates a method 200 of operating a beacon-augmented surveillance system. The method 200 will be described as it would be performed by the surveillance system 110 depicted in FIG. 1. However, it will be understood that the method 200 may be performed in any suitable surveillance system.

At 210, the method 200 generates image data. The generating at 210 may be performed by, for example, the camera 114 depicted in FIG. 1.

At 220, the method 200 generates image metadata that indicates a surveillance system identifier. The generating at 220 may be performed by, for example, the controller 112 depicted in FIG. 1.

As noted above, the image metadata may indicate, for example, a surveillance system identifier that is associated with the surveillance system 110 and/or the camera 114, an image timestamp indicating a time at which the image data was captured, other data, or any combination thereof.

In some implementations, the surveillance system identifier may be a serial number that is unique to the surveillance system 110 and/or camera 114. For example, the serial number may be assigned by the manufacturer of the surveillance system 110 and/or camera 114. Additionally or alternatively, the serial number may be assigned by a security services provider associated with the surveillance system 110, camera 114, and/or server 120. The serial number may be unique to the surveillance system 110 and/or camera 114. Additionally or alternatively, the surveillance system identifier may be an address, for example a MAC address of the surveillance system 110. The image timestamp may be a time at which a particular image was captured.

In other implementations, the controller 112 may generate a surveillance system identifier that is a dynamic value known to a central server, for example, server 120, but that is difficult for an unauthorized system to predict. For example, a serial number associated with the surveillance system 110, along with other data (for example, nonce values, counter values, timestamps, etc.), may be encoded, encrypted, or otherwise obfuscated when included within a beacon 117. The surveillance system identifier may be a rolling identifier. The term “rolling identifier” is used herein to refer to an identifying code, unique to a device or a user of the device, that is periodically changed (i.e., “rolled”). The surveillance system 110 may encrypt the serial number and clock, nonce or counter information using secret keys and functions known only to the surveillance system 110 and a central server, for example, the server 120.

A rolling identifier for the surveillance system 110 may also indicate a timestamp that may be used as an image timestamp. For example, the surveillance system 110 may be configured to maintain relatively accurate time (for example, UTC) information, such as by using a thirty ppm, sixteen kHz crystal oscillator as a clock. Accordingly, a rolling identifier included in the image metadata may indicate both a surveillance system identifier of the surveillance system 110 and a time at which the surveillance system 110 captured a particular image, and may do so in such a way that it can only be decoded by the server 120.

At 230, the method 200 transmits the image data and the image metadata to a server. The transmitting at 230 may be performed by, for example, the controller 112 (via the communication channel 113) depicted in FIG. 1 and/or the beacon transmitter 116 depicted in FIG. 1.

At 240, the method 200 generates a beacon that indicates the surveillance system identifier. The generating at 240 may be performed by, for example, the controller 112 depicted in FIG. 1. The surveillance system identifier may be indicated by including a serial number associated with the surveillance system 110, as noted above. Additionally or alternatively, the surveillance system identifier may be indicated by a rolling identifier that can only be decoded by the server 120, as noted above.

At 250, the method 200 transmits the beacon. The beacon may be similar to the beacon 117 depicted in FIG. 1. The transmitting at 250 may be performed by, for example, the beacon transmitter 116 depicted in FIG. 1.

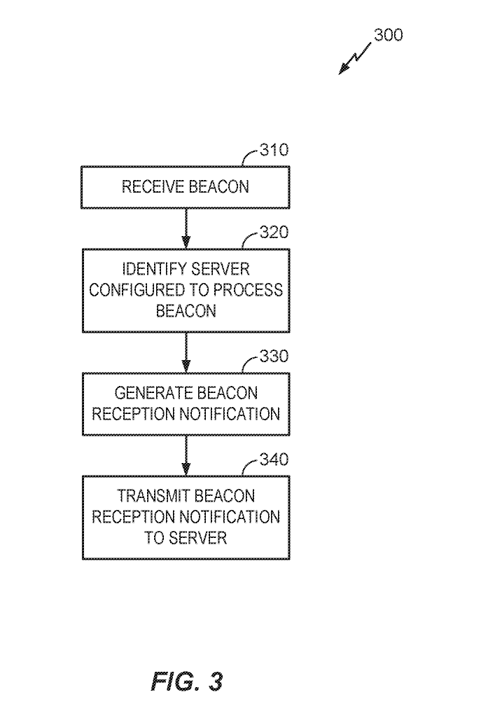

FIG. 3 generally illustrates a method 300 of generating and transmitting a beacon reception notification. The method 300 will be described as it would be performed by the wireless device 130 depicted in FIG. 1. However, it will be understood that the method 300 may be performed by any suitable wireless device.

At 310, the method 300 receives a beacon. The beacon received at 310 may be similar to, for example, the beacon 117 depicted in FIG. 1. The receiving at 310 may be performed by a transceiver associated with the wireless device 130 depicted in FIG. 1.

At 320, the method 300 identifies a server configured to process the beacon. The identified server may be similar to, for example, the server 120 depicted in FIG. 1. In some implementations, the beacon 117 received at 310 may indicate the identity or address of the server 120. Additionally or alternatively, the wireless device 130 is configured to recognize, based on a characteristic of the beacon 117, that the server 120, whose identity and address is predetermined, is configured to process the beacon 117. The characteristic may include, for example, a beacon status of the beacon 117, a transceiver type or communication protocol with which the beacon 117 was received, information in the beacon 117 indicating that the beacon 117 is used for public safety purposes, or any other suitable characteristic.

At 330, the method 300 generates a beacon reception notification. The beacon reception notification may be similar to the beacon reception notification 131 depicted in FIG. 1. The beacon reception notification 131 may include part or all of the information encoded in received beacon 117, including, for example, a surveillance system identifier associated with the surveillance system 110.

The beacon reception notification 131 may further include a wireless device identifier associated with the wireless device 130. The wireless device identifier may be, for example, assigned by a manufacturer of the wireless device 130 or a service provider associated with the wireless device 130).

The beacon reception notification 131 may further include a beacon timestamp that indicates, for example, a time that the beacon 117 was received from the surveillance system 110 and/or a time that the beacon reception notification 131 was transmitted by the wireless device 130.

The beacon reception notification 131 may further include authentication information (for example, a secret key or code, a digital certificate, etc.) that may be used by the server 120 to confirm the identity of the wireless device 130 from which the beacon reception notification 131 is received. For example, a beacon reception notification 131 may include a code from a hash function that can be decoded by the server 120. The beacon reception notification 131 may be sent immediately after receipt of broadcasts (e.g., when related to an alert), buffered, or scheduled along with other scheduled transmissions.

At 340, the method 300 transmits the beacon reception notification 131 to the server 120. The transmitting at 340 may be performed by, for example, a transceiver associated with the wireless device 130.

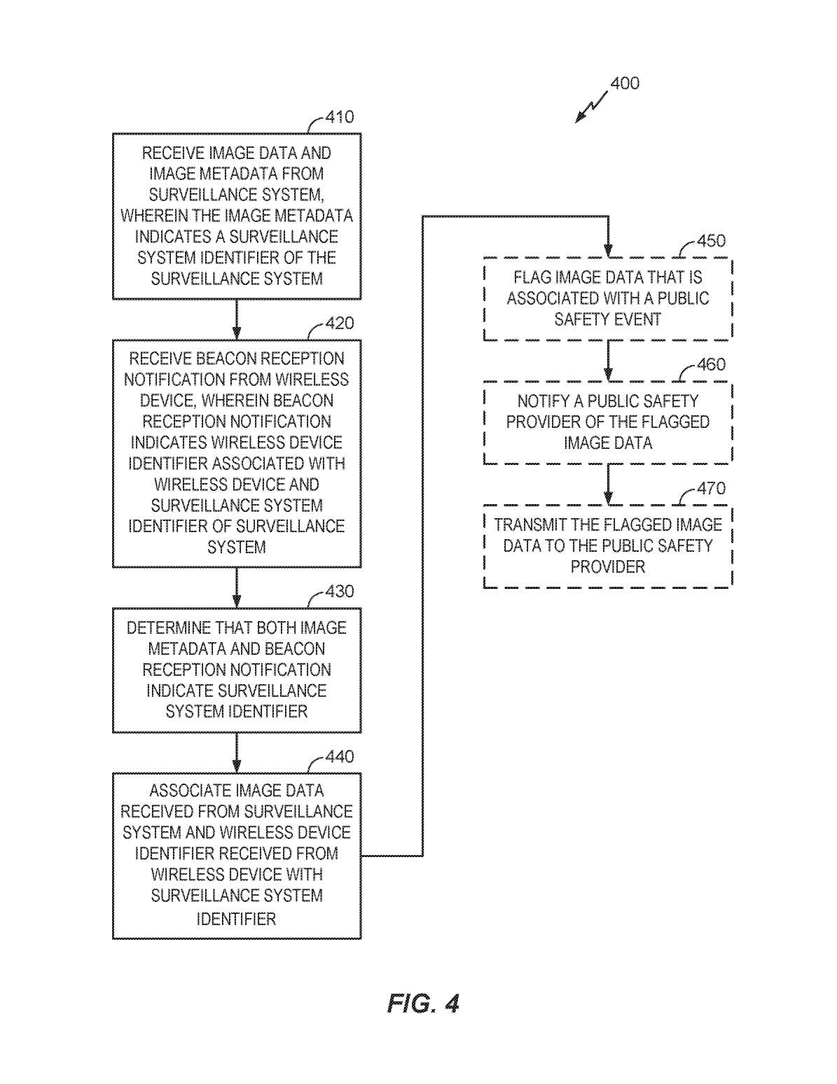

FIG. 4 generally illustrates a method 400 of managing beacon-augmented surveillance data. The method 400 will be described as it would be performed by the server 120 depicted in FIG. 1. However, it will be understood that the method 400 may be performed by any suitable server or similar device.

At 410, the method 400 receives image data and image metadata from a surveillance system, wherein the image metadata indicates a surveillance system identifier of the surveillance system. The surveillance system may be similar to, for example, the surveillance system 110 depicted in FIG. 1. The receiving at 410 may be performed by, for example, the server controller 122 depicted in FIG. 1.

In some implementations, the image metadata received at 410 may also indicate an image timestamp associated with capture of the image data. Additionally or alternatively, the server 120 may generate an image data reception timestamp that is added to the image metadata received at 410. The image data reception timestamp may indicate the time at which the image data was received from the surveillance system 110.

At 420, the method 400 receives a beacon reception notification from a wireless device 130, wherein the beacon reception notification indicates a wireless device identifier associated with the wireless device 130 and the surveillance system identifier of the surveillance system. The wireless device 130 may be similar to, for example, the wireless device 130 depicted in FIG. 1, and the beacon reception notification may be similar to, for example, the beacon reception notification 131 depicted in FIG. 1. The receiving at 420 may be performed by, for example, the server controller 122 depicted in FIG. 1.

In some implementations, the beacon reception notification 131 received at 420 may also indicate a beacon timestamp associated with reception of the beacon 117 at the wireless device 130.

As noted above, the surveillance system identifier may be indicated in either the image metadata received from the surveillance system 110 (at 410) or in the beacon reception notification 131 received from the wireless device 130 (at 420). If the surveillance system identifier and/or a timestamp is indicated using a rolling identifier, then the server 120 may decipher the rolling identifier to determine the actual value of the surveillance system identifier.

In some implementations, this process may involve comparing the rolling identifier received in, for example, the beacon reception notification 131 to several possible serial codes generated by a random or pseudo-random number generator algorithm, or applying a reverse algorithm which uses the rolling identifier as an input and outputs the corresponding surveillance system identifier and/or timestamp.

At 430, the method 400 determines that both the image metadata and the beacon reception notification indicate the surveillance system identifier. The determining at 430 may be performed by, for example, the server controller 122 depicted in FIG. 1. For example, the server 120 may be configured to receive image data and image metadata from an indefinite number of distinct surveillance systems and may be further configured to receive beacon reception notifications from an indefinite number of distinct wireless devices analogous to the wireless device 130. However, in accordance with the method 400, the server 120 may be configured to organize the received image data, image metadata, and beacon reception notifications based on the respective surveillance system identifiers associated therewith. Accordingly, the server 120 would be configured to recognize that the image data and image metadata received at 410 are associated with a particular surveillance system (i.e., the surveillance system 110) and that the beacon reception notification 131 received at 420 is associated with the same particular surveillance system (i.e., the surveillance system 110).

In some implementations, the method 400 may also determine at 430 that the image timestamp indicated by the image metadata and the beacon timestamp indicated by the beacon reception notification 131 are identical and/or overlapping.

At 440, the method 400 associates in storage the surveillance system identifier, the image data received from the surveillance system 110, and the wireless device identifier received from the wireless device 130. The associating at 440 may be performed by, for example, the server controller 122 and/or the server database 124.

In some implementations, the method 400 may also associate at 440 the image data received from the surveillance system and the wireless device identifier received from the wireless device 130 with an image timestamp, an image data reception timestamp, a beacon timestamp, or any combination thereof.

At 450, the method 400 optionally flags image data that is associated with a public safety event. The public safety event may be a crime or other abnormal event. The flagging at 450 may be responsive to, for example, a determination that the public safety event occurred. The determination may be made by, for example, a user of the surveillance system 110, an operator of the server 120, or an algorithm associated with the surveillance system 110 or the server 120.

In some implementations, a user of the surveillance system 110 may determine that a crime or abnormality has occurred (for example, after the fact). The user may then ascertain a time or time interval at which the crime or abnormality occurred. For example, the user may observe at eight in the morning that his car is missing from the spot where it was parked at midnight the night before (within, for example, the surveillance imaging zone 115 and/or the beacon transmission zone 118). The user may then flag the time interval 12:00:00-08:00:00. The user may then notify the server 120 of the flagged interval (for example, via the surveillance system 110 and/or the communication channel 113). In response, the server 120 would determine a surveillance system identifier associated with the surveillance system 110 and flag image data that is associated with the determined surveillance system identifier and a timestamp within the flagged interval.

In other implementations, the user of the surveillance system 110 or the operator of the server 120 may review the image data, for example, by displaying the image data and observing the displayed image data. The displaying and observing may be performed in real time or reviewed after the fact. The observer may then ascertain a time or time interval that is relevant to the public safety event and flag the relevant time interval.

In yet other implementations, the surveillance system 110 (for example, the controller 112) and/or the server 120 (for example, the server controller 122) may be configured to automatically flag a time or time interval based on an algorithm. For example, the algorithm may be a motion detection algorithm wherein the image data is processed to determine if movement is detected within the surveillance imaging zone 115, and if movement is detected at a particular time, then the time associated with the detected movement is flagged.

As another example, the algorithm may be a foreign wireless device algorithm that tracks the wireless device identifiers of wireless devices from which beacon reception notifications are received. A particular beacon transmission zone 118 may be associated with local wireless devices having familiar wireless device identifiers (for example, a wireless device associated with a security guard that typically works within the beacon transmission zone 118). The foreign wireless device algorithm may be configured to automatically flag a time or time interval if a beacon reception notification 131 is received from a foreign wireless device, i.e., a wireless device 130 that does not have a familiar wireless device identifier. The familiar wireless device identifiers may be expressly entered by a user of the surveillance system 110 or simply learned by the server 120 based on a past history of received beacon reception notifications 131.

As yet another example, the algorithm may be a facial recognition algorithm in which faces of persons in the image data are matched to facial image profiles of flaggable persons (for example, criminals, suspects, fugitives, victims, etc.) The image data may be flagged by the facial recognition algorithm based on a positive match between a face of a person in the image data and a flaggable person. Textual recognition algorithms are also possible, in which the image data may be flagged based on a positive match between, for example, a license plate number recognized in the image data and the license number of a flaggable vehicle (for example, a stolen car or a car registered to a person of interest).

At 460, the method 400 optionally notifies a public safety provider of the flagged image data. The notifying at 460 may be performed in any suitable manner, for example, by generating a message addressed to an appropriate public safety provider or by instructing the user of the surveillance system 110 or the operator of the server 120 to notify the appropriate public safety provider. The instructing may be performed, for example, by generating an instruction message and transmitting the notification message to the user of the surveillance system 110 or the operator of the server 120, or by displaying an instruction message to the user of the surveillance system 110 or the operator of the server 120.

At 470, the method 400 optionally transmits the flagged image data to the public safety provider. The transmitting at 470 may be performed, for example, by querying the server database 124 for flagged image data, retrieving the flagged image data from the server database 124, associating the flagged image data with a surveillance system identifier and/or a timestamp to generate flagged image data metadata, and transmitting the flagged image data and flagged image data metadata to an appropriate public safety provider. The transmitting at 470 may be performed by, for example, the server controller 122.

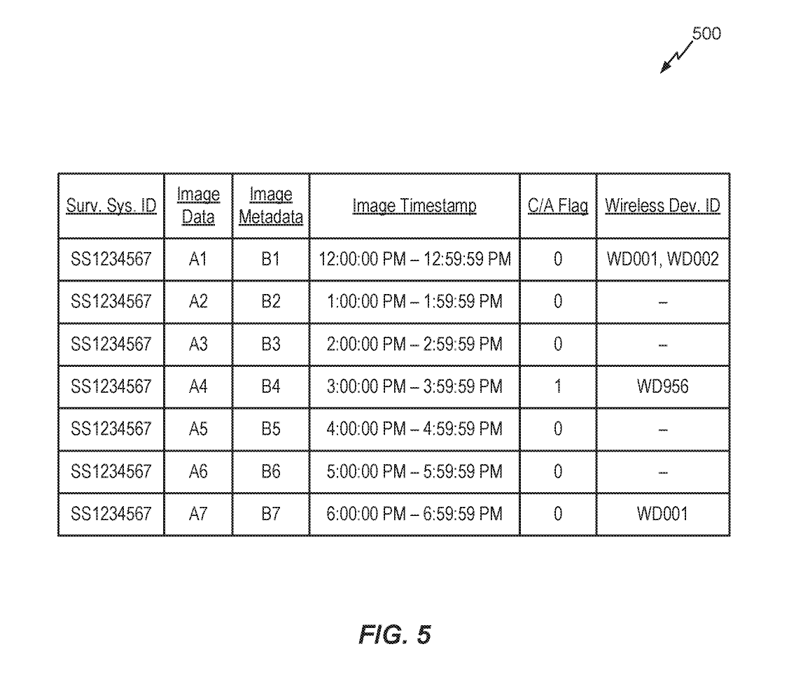

FIG. 5 generally illustrates beacon-augmented surveillance data as it might be managed in accordance with the method 400 of FIG. 4. The surveillance data may be organized, stored, managed, and/or maintained in any suitable manner. However, the surveillance data is depicted in FIG. 5 as a data table 500.

A narrative is herein provided for purposes of illustration in which the data table 500 is constructed on the basis of events that occur within the wireless communications environment 100 depicted in FIG. 1.

In the present narrative, the surveillance system 110 captures a sequence of images via the camera 114 and generates image data from the surveillance imaging zone 115, referred to herein by the arbitrary label A1. A first car belonging to a first person and a second car belonging to a second person occupy the surveillance imaging zone 115. Accordingly, the image data A1 includes images of the first car and the second car, which are parked within the surveillance imaging zone 115 during a one hour time interval starting at 12:00:00 PM and ending at 12:59:59 PM.

The image data A1 is generated by the surveillance system 110 during the one hour time interval starting at 12:00:00 PM and ending at 12:59:59 PM. Accordingly, the surveillance system 110 generates image metadata B1 with a timestamp indicating the time interval 12:00:00 PM-12:59:59 PM. It will be understood that the time interval may be longer than one hour or shorter than one hour, and may even be so short as an instant of time, i.e., a time at which an individual image is captured rather than a time interval over which a sequence of images are captured.

The metadata B1 further includes the surveillance system identifier of the surveillance system 110, in this case, an arbitrary serial number known to the surveillance system 110 and labeled for purposes of illustration as #SS1234567.

The image data A1 and image metadata B1 (which includes the surveillance system identifier #SS1234567 and the image timestamp 12:00:00 PM12:59:59 PM) are then transmitted to the server 120.

Upon receiving of the image data A1 and image metadata B1 from the surveillance system 110, the server 120 generates a first entry into the data table 500. As shown in the top row of the data table 500 (immediately below the column header row), the first entry includes the image data A1 and image metadata B1. The server 120 also decodes the image metadata B1 to determine the surveillance system identifier of the surveillance system from which the image data A1 was received (#SS1234567 in the present narrative) and an image timestamp associated with the image data A1 (12:00:00 PM-12:59:59 PM in the present narrative). The surveillance system identifier #SS1234567, the image data Al, the image metadata B1, and the image timestamp 12:00:00 PM-12:59:59 PM are all included in the first entry of the data table 500.

During the time interval 12:00:00 PM-12:59:59 PM, the first person having a first wireless device and the second person having a second wireless device occupy the beacon transmission zone 118. Moreover, the surveillance system 110 generated at least one beacon 117 during that time interval, which was received by both the first wireless device and the second wireless device. Accordingly, the first and second wireless devices generated respective beacon reception notifications 131, and transmitted the respective beacon reception notifications 131 to the server 120. The first beacon reception notification 131 included a wireless device identifier associated with the first wireless device (#WD001 in the present narrative) and the surveillance system identifier associated with the surveillance system 110 from which the beacon 117 was received (#SS1234567 in the present narrative). The second beacon reception notification 131 included a wireless device identifier associated with the second wireless device (#WD002 in the present narrative) and the surveillance system identifier associated with the surveillance system 110 from which the beacon 117 was received (#SS1234567 in the present narrative).

Upon receiving of the first beacon reception notification 131 from the first wireless device #WD001, the server 120 determines a beacon timestamp associated with the first beacon reception notification 131. Because the first beacon reception notification 131 was associated with the surveillance system identifier #SS1234567 and was generated during the time interval 12:00:00 PM-12:59:59 PM, the wireless device identifier (#WD001 in the present narrative) is provided to the first entry in the data table 500. In the same manner, the wireless device identifier of the second wireless device #WD002 is also provided to the first entry.

At one o'clock in the afternoon, the first person (having the first wireless device #WD001 in his or her pocket) and the second person (having the second wireless device #WD002 in his or her pocket) get in the first car and drive away. It will be understood that image data A2 and image metadata B2 may be generated during the time interval 1:00:00 PM-1:59:59 PM and transmitted to the server 120, which would in turn generate the second entry shown in the data table 500 of FIG. 5. The image data A2 would show the second car alone within the surveillance imaging zone 115. Because the first person and second person have driven away, they are no longer within the beacon transmission zone 118. And because they have brought their respective wireless devices with them, the beacons 117 transmitted by the surveillance system 110 do not result in beacon reception notifications 131. Accordingly, the second entry in the data table 500 includes blanks under the wireless device identifier column header.

A second hour passes without any change in circumstances, resulting in a third entry in the data table 500 that includes image data A3 and image metadata B3.

However, at three o'clock, a burglar arrives and breaks into the second car. Accordingly, the camera 114 captures images of the burglary and transmits image data A4 to the server 120. The server 120 generates a fourth entry in the data table 500 that includes inculpatory evidence of the burglary, i.e., image data A4.

The burglar wears a mask and can not be identified based on the image data A4. However, the burglar's wireless device is in his pocket and receives a beacon 117 from the surveillance system 110. The burglar's wireless device is (perhaps without the burglar's realization) configured to receive the beacon 117 and generate a beacon reception notification 131. The beacon reception notification 131 includes the surveillance system identifier #SS1234567 and the wireless device identifier associated with the burglar's wireless device (#WD956 in the present narrative). Upon receiving the beacon reception notification 131 from the burglar's wireless device, the server 120 provides the wireless device identifier #WD956 to the fourth entry.

The burglar leaves at four o'clock, after completing the burglary. The surveillance system 110 generates image data A5 and image metadata B5 during the 4:00:00 PM to 4:59:59 PM time interval and transmits the image data A5 and image metadata B5 to the server 120, which generates a fifth entry into the data table 500. Likewise, the surveillance system 110 generates image data A6 and image metadata B6 during the 5:00:00 PM to 5:59:59 PM time interval and transmits the image data A6 and image metadata B6 to the server 120, which generates a sixth entry into the data table 500. Moreover, the surveillance system 110 generates image data A7 and image metadata B7 during the 6:00:00 PM to 6:59:59 PM time interval and transmits the image data A7 and image metadata B7 to the server 120, which generates a seventh entry into the data table 500.

At five o'clock, the first person returns home and observes that the second car has been burglarized. The first person calls a security service provider associated with the server 120 and notifies the security service provider that a burglary occurred within the surveillance imaging zone 115 at some point between one o'clock and five o'clock. The security service provider ascertains the surveillance system identifier associated with the surveillance system 110 and queries image data from the data table 500 that is associated with the surveillance system identifier #SS1234567 and the time intervals between 1:00:00 PM and 5:00:00. Based on the query, the security service provider reviews the image data A2, A3, and A4 and observes that the image data A4 includes inculpatory evidence involving a crime or abnormality.

The security service provider then flags the image data A4 (represented by a ‘1’ in the C/A flag column of the data table 500) and further notes that a wireless device associated with wireless device identifier #WD956 transmitted a beacon reception notification 131 to the server 120 during the flagged time interval. The security service provider may then notify an appropriate public safety authority and/or transmit the image data A4 and wireless device identifier #WD956 to the public safety authority. It will be understood that the public safety authority may have the ability and legal right to ascertain the identity of the burglar based on the wireless device identifier #WD956.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences, and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., wireless device). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps, and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a surveillance system, comprising:
generating image data;
generating image metadata that indicates a surveillance system identifier;
transmitting the image data and the image metadata to a server;
generating a beacon that indicates the surveillance system identifier; and
transmitting the beacon.

2. The method of claim 1, wherein:
the generating of the image data is associated with a surveillance imaging zone; and
the transmitting of the beacon is associated with a beacon transmission zone;
wherein at least a portion of the surveillance imaging zone overlaps with at least a portion of the beacon transmission zone.

3. The method of claim 1, wherein the image metadata includes an image timestamp indicating a time or time interval associated with the generating of the image data.

4. The method of claim 1, wherein the beacon includes a rolling identifier that is encrypted based on a random number and changes over time.

5. The surveillance system of claim 4, wherein the rolling identifier is traceable to the surveillance system.

6. The surveillance system of claim 4, wherein the rolling identifier is traceable to a timestamp.

7. The surveillance system of claim 1, wherein the beacon includes the surveillance system identifier and further includes a timestamp.

8. A surveillance system apparatus, comprising:
a camera configured to generate image data;
a controller configured to:
generate image metadata that indicates a surveillance system identifier;
upload the image data and the image metadata to a server; and
generate a beacon that indicates the surveillance system identifier; and
a transceiver configured to transmit the beacon.

9. The surveillance system apparatus of claim 8, wherein:
the camera is associated with a surveillance imaging zone; and
the transceiver is associated with a beacon transmission zone;
wherein at least a portion of the surveillance imaging zone overlaps with at least a portion of the beacon transmission zone.

10. The surveillance system apparatus of claim 8, wherein the image metadata includes an image timestamp indicating a time or time interval associated with the generating of the image data.

11. The surveillance system apparatus of claim 8, wherein the beacon includes a rolling identifier that is encrypted based on a random number and changes over time.

12. The surveillance system apparatus of claim 11, wherein the rolling identifier is traceable to the surveillance system.

13. The surveillance system apparatus of claim 11, wherein the rolling identifier is traceable to a timestamp.

14. The surveillance system apparatus of claim 11, wherein the beacon includes the surveillance system identifier and further includes a timestamp.

15. A surveillance system apparatus, comprising:
means for generating image data;
means for generating image metadata that indicates a surveillance system identifier;
means for transmitting the image data and the image metadata to a server;
means for generating a beacon that indicates the surveillance system identifier; and
means for transmitting the beacon.

16. The surveillance system apparatus of claim 15, wherein:
the image data is associated with a surveillance imaging zone;
the beacon is associated with a beacon transmission zone; and
at least a portion of the surveillance imaging zone overlaps with at least a portion of the beacon transmission zone.

17. The surveillance system apparatus of claim 15, wherein the image metadata includes an image timestamp indicating a time or time interval associated with the generating of the image data.

18. The surveillance system apparatus of claim 15, wherein the beacon includes a rolling identifier that is encrypted based on a random number and changes over time.

19. The surveillance system apparatus of claim 18, wherein the rolling identifier is traceable to the surveillance system.

20. The surveillance system apparatus of claim 18, wherein the rolling identifier is traceable to a timestamp.

21. The surveillance system apparatus of claim 15, wherein the beacon includes the surveillance system identifier and further includes a timestamp.

22. A method of managing beacon-augmented surveillance data, comprising:
receiving, at a server, image data and image metadata from a surveillance system, wherein the image metadata indicates a surveillance system identifier of the surveillance system;
receiving, at the server, a beacon reception notification from a wireless device, wherein the beacon reception notification indicates a wireless device identifier associated with the wireless device and the surveillance system identifier of the surveillance system;
determining that both the image metadata and the beacon reception notification indicate the surveillance system identifier;
associating in storage, at the server, the surveillance system identifier, the image data received from the surveillance system, and the wireless device identifier received from the wireless device.

23. The method of claim 22, further comprising:
flagging image data that is associated with a public safety event;
notifying a public safety provider of the flagged image data; and
transmitting the flagged image data to the public safety provider.

24. The method of claim 22, wherein:
the image metadata includes an image timestamp indicating a time or time interval associated with the image data; and
associating in storage further comprises associating in storage the surveillance system identifier, the image data received from the surveillance system, the wireless device identifier received from the wireless device, and the image timestamp.

25. The method of claim 22, wherein the beacon reception notification includes a rolling identifier that is encrypted based on a random number and changes over time.

26. The method of claim 25, wherein the rolling identifier is traceable to the surveillance system.

27. The method of claim 25, wherein the rolling identifier is traceable to a beacon timestamp.

28. The method of claim 22, wherein the beacon reception notification includes the surveillance system identifier and further includes a beacon timestamp.

29. A server apparatus, the server apparatus being configured to:
receive image data and image metadata from a surveillance system, wherein the image metadata indicates a surveillance system identifier of the surveillance system;
receive a beacon reception notification from a wireless device, wherein the beacon reception notification indicates a wireless device identifier associated with the wireless device and the surveillance system identifier of the surveillance system;
determine that both the image metadata and the beacon reception notification indicate the surveillance system identifier;
associate in storage the surveillance system identifier, the image data received from the surveillance system, and the wireless device identifier received from the wireless device.

30. The server apparatus of claim 29, being further configured to:
flag image data that is associated with a public safety event;
notify a public safety provider of the flagged image data; and
transmit the flagged image data to the public safety provider.

31. The server apparatus of claim 29, wherein:
the image metadata includes an image timestamp indicating a time or time interval associated with the image data; and
the server apparatus is further configured to associate in storage the surveillance system identifier, the image data received from the surveillance system, the wireless device identifier received from the wireless device, and the image timestamp.

32. The server apparatus of claim 29, wherein the beacon reception notification includes a rolling identifier that is encrypted based on a random number and changes over time.

33. The server apparatus of claim 32, wherein the rolling identifier is traceable to the surveillance system.

34. The server apparatus of claim 32, wherein the rolling identifier is traceable to a beacon timestamp.

35. The server apparatus of claim 29, wherein the beacon reception notification includes the surveillance system identifier and further includes a beacon timestamp.

36. A server apparatus, the server apparatus comprising:
means for receiving, at a server, image data and image metadata from a surveillance system, wherein the image metadata indicates a surveillance system identifier of the surveillance system;
means for receiving, at the server, a beacon reception notification from a wireless device, wherein the beacon reception notification indicates a wireless device identifier associated with the wireless device and the surveillance system identifier of the surveillance system;
means for determining that both the image metadata and the beacon reception notification indicate the surveillance system identifier;
means for associating in storage, at the server, the surveillance system identifier, the image data received from the surveillance system, and the wireless device identifier received from the wireless device.

37. The server apparatus of claim 36, further comprising:
means for flagging image data that is associated with a public safety event;
means for notifying a public safety provider of the flagged image data; and
means for transmitting the flagged image data to the public safety provider.

38. The server apparatus of claim 36, wherein:
the image metadata includes an image timestamp indicating a time or time interval associated with the image data; and
means for associating in storage further comprises means for associating in storage the surveillance system identifier, the image data received from the surveillance system, the wireless device identifier received from the wireless device, and the image timestamp.

39. The server apparatus of claim 36, wherein the beacon reception notification includes a rolling identifier that is encrypted based on a random number and changes over time.

40. The server apparatus of claim 39, wherein the rolling identifier is traceable to the surveillance system.

41. The server apparatus of claim 39, wherein the rolling identifier is traceable to a beacon timestamp.

42. The server apparatus of claim 36, wherein the beacon reception notification includes the surveillance system identifier and further includes a beacon timestamp.
